(19) United States
(12) Patent Application Publication
(10) Pub. No.: US 2005/0261828 A1
(43) Pub. Date: Nov. 24, 2005

(54) Device and method for energy-minimizing human ground routing

(76) Inventors: George E. Crowder JR., Fairfax, VA (US); Jerry L. Mehlberg, Burke, VA (US)

Correspondence Address: Michael G. Petit, P.O. Box 91929, Santa Barbara, CA, 93190-1929, US

(21) Appl. No.: 10/848,192

(22) Filed: May 18, 2004

(51) Int. Cl. G01C 21/30

(52) U.S. Cl. 701/210

(57) ABSTRACT

There are certain tasks that require humans to proceed on foot over intervening terrain (that may include “improved” segments such as paved roads and bridges) from some starting point A to some objective or destination point B, and perhaps thence to additional points C and D. Exemplars of civilian endeavors include forest firefighting, search and rescue, surveying, exploration, and recreational hiking. Military applications include infantry and special operations forces movements. In many of these endeavors, it is desired to be as rested as possible when reaching the destination in order to have the energy remaining to successfully or optimally accomplish some “objective” activity. The present invention provides a methodology for computing the route for a human being traveling on foot over arbitrary terrain from any point A to any other point B (and if desired to points C, D, etc. beyond) such that the human energy expended walking from Point A to point B (and any points beyond) is minimized. The energy-minimizing human ground routing system (EHGRS) enables recreational hikers, Army and Marine Corps infantry patrols, special operations forces, forest firefighters, geologists and search and rescue teams to quickly find the energy-minimizing route between any two points over any terrain so that they arrive at their destination with the minimum possible degradation of their performance due to fatigue, in contrast to routing developed based on human judgment.

### BACKBROUND OF THE INVENTION

1. Field of the Invention

A method and device for computing overland ground routes for humans traveling on foot over arbitrary terrain between any set of two or more sequential points that identifies an optimal route that will minimize the human energy expended traveling between the points.

2. Prior Art

The following review of prior art covers two relevant areas. The first area reviews the results of empirical research into the physiology of human energy expenditure documented in the literature, augmented by additional field research and computer modeling by the inventors. The second area reviews the results of research and algorithm development in the field of finding optimal paths in networks or graphs.

Research on human energy expenditure conducted by Ainsworth¹, Douglas and Haldane², Keys, et al.³, Mahadeva, et al.⁴, Margaria, et al.^{5, 6}, Minetti, et al.^{7, 8}, Passmore and Dumin⁹, and Susta, et al.¹⁰ provides data relating human energy expenditure per unit time (i.e., power) to walking speed, terrain gradient, and the mass of the walker. Passmore and Durnin's research¹¹ also provides data relating human energy expenditure (while walking) to terrain surface type and to load being carried. Mahadeva, et al.¹² found that human energy expenditure while walking at various speeds is a function of body weight. Passmore and Dumin¹³ and Mahadeva, et al.¹⁴ found that variation in individual energy expenditure is small compared to total energy expenditure and to variation due to walking speed and terrain gradient, respectively. Research by Gray, et al.¹⁵, Horvath and Golden¹⁶, Nelson, et al.¹⁷, and Robinson¹⁸ shows that temperature has little effect on human energy expenditure (with the exception of Arctic temperatures, which greatly increase human energy expenditure for any given activity).

Passmore and Dumin's data¹⁹ and Mahadeva's research²⁰ on human energy expenditure show that there is a basal human energy expenditure rate that occurs regardless of activity (i.e., at zero velocity) and that it is more or less proportional to the weight (or mass) of the individual. Passmore and Durnin captured data from empirical laboratory experiments and produced a set of curves relating walking velocity and positive (uphill) gradient r (defined as rise over run) to human energy expended per unit time²¹. Other literature on the effects of gradient on human energy expenditure strongly supports Passmore and Dumin's findings^{22, 23, 24, 25, 26}. The literature on human energy expenditure also indicates that traversing negative (downhill) gradients (i.e., r<0) at constant specific power consumes less energy than does traversing flat terrain for −0.2≦r<0, but that when r<−0.2, energy consumption is greater than for flat terrain^{27, 28, 29, 30, 31}. Passmore and Durnin's results also show that a simple multiplier for different terrain surface types (e.g., asphalt, grass, sand, etc.) can be used to capture the effects of the terrain surface type on human energy expenditure for a given walking velocity and gradient.

Available terrain elevation data, e.g., Defense Terrain Elevation Data (DTED)³³ or U.S. Geological Survey (USGS) National Elevation Dataset (NED) data³⁴, are represented as a terrain elevation within a rectangular grid cell where the elevation for a given cell with dimensions d×d meters, is an average elevation of the terrain in that cell, usually as measured by radar. FIG. 1 illustrates such a terrain grid structure, where the average elevation in each d×d meters cell is in the center of the cell.

If each cell of a collection of such cells over a geographic area is represented as a network node and each node is connected to the adjacent eight nodes by arcs, the terrain is well-represented as a network of nodes and arcs. FIG. 2 is the transformation of FIG. 1 into the network (node/arc) representation. Note that the white center node represents the center grid cell in FIG. 1 with elevation 656 m and the remaining black nodes of FIG. 2 correspond to the other grid cells in FIG. 1. If the distance between a given node (cell) and its adjacent non-diagonal nodes is d, then the distance from the given node to its adjacent diagonal nodes is \sqrt{2}d. The change in elevation between any two adjacent nodes is given by the arithmetic difference of their respective elevations. This can be converted to a gradient by dividing the change in elevation by the distance between the adjacent nodes (i.e., rise over run). Thus each arc in FIG. 2 can be associated with a length (d for non-diagonal arcs, \sqrt{2}d for diagonal arcs), gradient r, terrain surface type (e.g., asphalt, grass, sand, etc.), and as we shall see, specific human energy expended in traversing the arc.

Several researchers have developed algorithms for finding an optimal path through a network or graph consisting of nodes and arcs connecting the nodes with a associated cost, in this case human specific energy expenditure, for traversing an arc from one node to an adjacent node. Optimization in this sense means minimizing the cost, or human specific energy expenditure. Such algorithms include Dijkstra's algorithm, the Ford-Bellman algorithm, Johnson's algorithm, and the Floyd-Warshall algorithm^{35,36}. Each of these algorithms has a different computational complexity³⁷, which equates to the amount of time it takes a given computer platform to arrive at an optimal solution given a specific network with A arcs and N nodes. Dijkstra's algorithm is of complexity O(A+N log N), Ford-Bellmann is O(AN), Johnson's algorithm is O(AN+N² log N), and Floyd-Warshall is O(N³)³⁸.

Current methods of developing human ground routes over arbitrary terrain are manual and based entirely on human judgment. Some currently available mapping software packages enable users to draw a cross-country route on a computer generated map and to generate Global Positioning System (GPS) coordinates for loading into a GPS navigation system device corresponding to the drawn route. Other software automatically develops automobile routes from one location to another over a road network. However, no existing software automatically develops cross-country ground routes for humans by minimizing human energy expenditure or on any other basis.

### SUMMARY OF THE INVENTION

It is a first object of the invention to provide a device and method for computing overland ground routes for humans on foot over arbitrary terrain, between any set of two or more sequential points, that minimize the human energy expended traveling between the points.

It is a further object of the invention to provide a computer readable medium bearing instructions that cause a computer to compute overland ground routes for humans on foot over arbitrary terrain, between any set of two or more sequential points, that minimize the human energy expended traveling between the points.

The above objectives are met by developing analytical equations for human specific energy expenditure as a function of terrain gradient r and terrain surface type (e.g., asphalt, grass, sand, etc.), automatically developing a terrain network representation from standard grid cell terrain elevation data (FIGS. 1 and 2), applying the developed human energy expenditure equations as the “cost” functions in the terrain network (FIG. 2), and automatically finding the route (i.e., the sequential set of arcs and nodes) from any user-designated starting point (node) in the network to any other point (node) in the network (and to any number of additional sequential points (nodes) in the network) using any one of the available network path optimization algorithms³⁹. FIG. 4 is an illustration of the optimal route through terrain between two points in Colorado produced by the present invention employing Dijktra's algorithm⁴⁰. The benefit of the present invention is that those using it can find and use the ground route that minimizes the energy expended in traveling on foot from a point to one or more subsequent points, leaving more energy at the destination point for remaining required/desired activities.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF THE DRAWINGS

FIG. 1 is an illustration of terrain elevation data represented by a set of grid cells.

FIG. 2 is an illustration of terrain elevation grid cell data transformed into a terrain network.

FIG. 3 is a chart of negative gradients versus velocity that will clarify certain points in the Preferred Embodiment discussion for the negative gradient case showing r, vᵣ and vₘₐₓ for r<0, cₛ=1, and Pₘₐₓ*=0.05748

FIG. 4 is an illustration of a route generated by the present invention.

FIG. 5 is a diagrammatic representation of the complete Energy Minimizing Human Ground Routing System invention.

### DESCRIPTION OF THE PREFERRED EMBODIMENTS

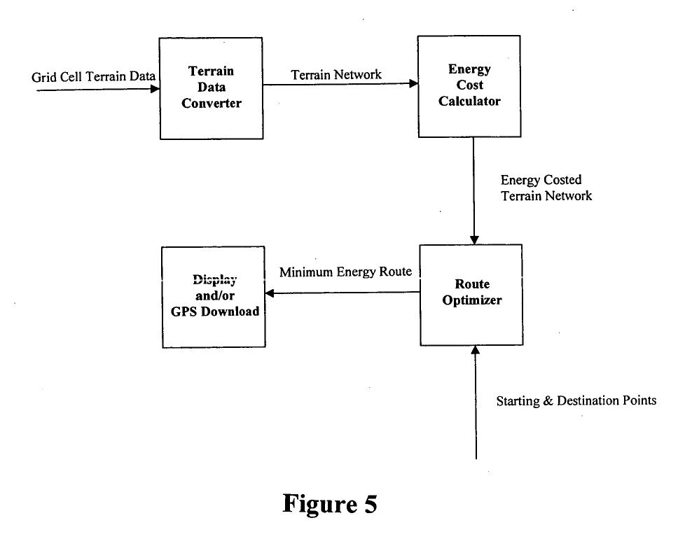

Artisans skilled in art will appreciate the value of illustrating the present invention by means of an example. Consider the problem of finding a ground route over rugged terrain from a starting point A to some objective point B (and by extension to additional objective points C, D, etc.) that minimizes the specific energy expended by a human or humans hiking from point A to point B (and to points C, D, etc.). FIG. 5 illustrates the process the present invention uses to produce an energy-minimizing route between user-selected points over intervening terrain for humans on foot. Each sub-process is described in what follows:

Network Creation

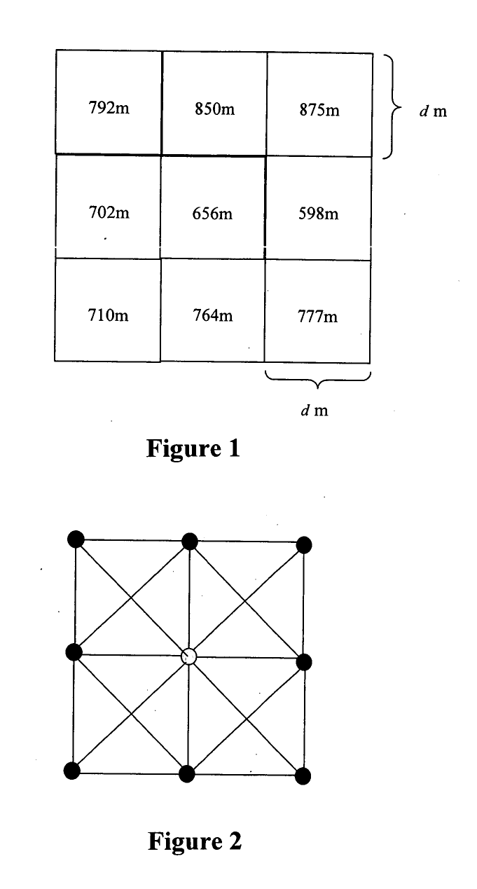

The present invention imports standard USGS or NIMA terrain elevation data and terrain surface type (asphalt, grass, sand, etc.) data in grid cell format (FIG. 1) and automatically converts it to terrain network format (FIG. 2). Each node in the network is assigned a terrain type and elevation from the original grid cell data. Each arc in the network has a length that is the length of each side of the grid cell for non-diagonal arcs and \sqrt{2} times that length for diagonal arcs. Then two gradients are computed for and associated with each arc in the network, one for traversing the arc in each direction. These two gradients per arc will have the same magnitude, but different algebraic sign.

Specific Energy Calculation for the Network

After the terrain network is created, the data it embodies (gradients, terrain surface type) is used to calculate the specific energy expended in traveling on an arc from one node to an adjacent node. Once again each arc has two energy expenditure values calculated and assigned, one from a figurative point A to point B, the other from point B to point A. Unlike gradients, the energy expenditures for an arc are different in both magnitude and algebraic sign, as we shall see from the following development of the energy expenditure equations.

Zero- and positive-gradient case. Conceptually, one would also expect human energy expenditure to be related to mv² when walking over flat terrain where a change in elevation is not a factor, since from basic physics we know that a moving object has energy

$$E = \frac{1}{2} {mv}^{2}$$

and due to friction, energy proportional to that has to be constantly input to a system to maintain an object of mass m at velocity v. Indeed, the empirical energy expenditure per unit time curves developed by Passmore and Dumin⁴¹ subjectively appear to be quadratic with velocity. Additionally, when walking uphill (i.e., gradient r>0), one would expect from basic physics that human energy expenditure would have an additional component related to mgh, where m is mass, g is the gravitational constant, and h is change in height. E=mgh is the basic physics equation expressing the change in energy associated with moving a mass m through a height h in a gravitational field. Once again, through subjective inspection of Passmore and Durnin's empirical energy expenditure curves⁴², it appears that the curve for each gradient is separated from the others by a factor that is related to the gradient. This conclusion is supported by the other literature on the effects of gradient on human energy expenditure^{43, 44, 45, 46, 47}. Consequently, human energy expenditure for zero and positive gradients was conceptualized through the following equation:

$$P = \frac{{β}_{0} ( m + l )}{t} + \frac{{β}_{1} {c}_{s} ( m + l ) {v}^{2}}{t} + \frac{{β}_{2} {c}_{s} ( m + l ) gh}{t} \qquad ( 1 )$$

where P is human energy expenditure per unit time (power), β₀, β₁ and β₂ are parameters to be estimated from the empirical data contained in the literature^{48, 49, 50, 51, 52, 53, 54, 55, 56}, cₛ is a dimensionless multiplier with a value that is different for each terrain surface type that can be inferred from the literature⁵⁷, m is the weight or mass of the human for whom energy expenditure is being estimated, l is the mass of any load being carried, g is the local gravitational constant, and h is the change in elevation for which the energy expenditure estimate is being made. Since Passmore and Durnin's empirical data is in terms of terrain gradient rather than h, we rewrite equation (1) as:

$$P = \frac{{β}_{0} ( m + l )}{t} + \frac{{β}_{1} {c}_{s} ( m + l ) {v}^{2}}{t} + \frac{{β}_{2} {c}_{s} ( m + l ) grd}{t} \qquad ( 2 )$$

where the gradient r is defined as:

$$r = \frac{h}{d} \qquad ( 3 )$$

and where d is the horizontal distance traveled while ascending (or descending) a height h. Now

$$\frac{d}{t} = v ,$$

so substituting in (2) yields:

$$P = \frac{{β}_{0} ( m + l )}{t} + \frac{{β}_{1} {c}_{s} ( m + l ) {v}^{2}}{t} + {β}_{2} {c}_{s} ( m + l ) grv \qquad ( 4 )$$

We can define new parameters to be estimated:

$${β}_{0}^{′} = \frac{{β}_{0}}{t} \qquad ( 5 )$$

and

$${β}_{1}^{′} = \frac{{β}_{1}}{t} \qquad ( 6 )$$

Substituting equations (5) and (6) into (4) yields the following equation:
P=β₀′(m+l)+β₁′cₛ(m+l)v²+β₂cₛ(m+l)grv (7)

To derive the human energy expenditure per unit of mass (the sum of the weight of the human and any load being carried), we divide both sides of equation (7) by (m+1) giving:

$${P}^{*} = \frac{P}{( m + l )} = {β}_{0}^{′} + {β}_{1}^{′} {c}_{s} {v}^{2} + {β}_{2} {c}_{s} grv \qquad ( 8 )$$

where P* is specific power or power per unit mass (human weight plus load).

Empirical data developed by Passmore and Dumin⁵⁸, and Magaria, et al.⁵⁹ were used to conduct a multiple regression⁶⁰ on equation (8) to estimate the parameters β₀′, β₁′; and β₂′, yielding the following functional equation relating specific power to terrain surface type (through cₛ), to velocity v, and to gradient r:
P*=0.02518+0.001588cₛv²+0.1254cₛrv (9)
Since g is a constant, 0.1254=β₂g in equation (9). The value of the adjusted coefficient of multiple determination⁶¹ (R²) associated with equation (9) is 0.93.

Ultimately, for r≧0, we wish to calculate a ground route between two arbitrary points that minimizes energy expenditure for humans walking at a constant specific power level, P₀*. Substituting P₀* for P* in equation (9) yields:
P₀=0.02518+0.001588cₛv²+0.1254cₛrv (10)

A numerical value for P₀* can be calculated from equation (10) by specifying cₛ, r, and v. From a practical standpoint, a selected constant human specific power P₀* should be one that is not too strenuous, but not too conservative either. A logical P₀* would be one based on zero-gradient, a cS associated with an asphalt (ideal) walking surface (see Table 1), and a maximum sustainable walking velocity v₀. However, P₀*(m+l)=P₀ should not exceed 7.3 kcal/min, since this is the maximum power that research indicates is sustainable over relatively long periods without resting⁶². Therefore, a logical value for P₀* is given by

$${P}_{0}^{*} = \frac{7.3}{m + l} .$$

For an individual human, m+l is the individual's weight plus any load being carried. For a group of humans there are multiple values of m+l (one for each individual in the group); it makes sense in that case to use the maximum individual value of m+l within the group to calculate P₀*. As an example, if we use an m+l of 280 pounds (127 kg), we obtain P₀*=0.05748 kcal/kg-min.

Rearranging the terms of equation (10) gives a standard quadratic equation in v:
0.001588cₛv²+0.1254cₛrv+0.02518−P₀*=0 (11)
Then let:
0.001588cₛ=a (12)
0.1254cₛr=b (13)
0.02518−P₀*=c (14)

Substituting equations (12)-(14) into equation (11):
av²+bv+c=0 (15)
Solving for v:

$$v = \frac{- b \pm \sqrt{{b}^{2} - 4 ac}}{2 a} \qquad ( 16 )$$

but since a>0, r>0, b>0 and walking involves only non-negative velocities, equation (16) may be replaced by:

$$v = \frac{- b + \sqrt{{b}^{2} - 4 ac}}{2 a} \qquad ( 17 )$$

Substituting the left-hand sides of equations (12)-(14) for a, b, and c in equation (17) yields:

$$v = \frac{- .1254 {c}_{s} r + \sqrt{.01573 {c}_{s}^{2} {r}^{2} + {c}_{s } ( .006352 {P}_{0}^{*} - .0001599 )}}{.003176 {c}_{s}} \qquad ( 18 )$$

Equation (18) is the formula for calculating the human walking velocity associated with constant human specific power P₀*, appropriate values of cₛ, and r≧0.

Now since

$$v = \frac{d}{t} ,$$

equation (18) can be restated as:

$$\frac{d}{t} = \frac{- .1254 {c}_{s} r + \sqrt{.01573 {c}_{s}^{2} {r}^{2} + {c}_{s } ( .006352 {P}_{0}^{*} - .0001599 )}}{.003176 {c}_{s}} \qquad ( 19 )$$

Solving for t:

$$t = \frac{.003176 {c}_{s} d}{- .1254 {c}_{s} r + \sqrt{.01573 {c}_{s}^{2} {r}^{2} + {c}_{s } ( .006352 {P}_{0}^{*} - .0001599 )}} \qquad ( 20 )$$

where d is the distance between one point and another, and t is the time it takes to cover that distance at velocity v with constant specific power P₀*. However, because we want an expression for human energy expenditure at constant specific power P₀* we need a mathematical expression for specific energy.

Since by definition:
E=Pt (21)
specific energy for this problem can be defined by:
E*=P₀*t (22)
Therefore, for a constant specific power P₀* over a time period t, equation (20) can be multiplied by P₀* to yield an expression for the specific energy required to travel from one point to another when r≧0:

$${}_{}^{+}{E}{}_{}^{*} = \frac{.003176 {c}_{s} {dP}_{0}^{*}}{- .1254 {c}_{s} r + \sqrt{.01573 {c}_{s}^{2} {r}^{2} + {c}_{s } ( .006352 {P}_{0}^{*} - .0001599 )}} \qquad ( 23 )$$

To summarize, equation (23), gives the human energy “cost” that we wish to minimize in calculating an optimal route when r≧0. Each arc in the terrain network has an associated cost from equation (23). It should be noted that when an arc connects nodes that have different terrain types and therefore different values of cₛ, the value of cₛ used in equation (23) (and its counterpart for the case where r<0) is the average of the cₛ values for each of the two nodes. Equation (20) provides the time estimate to travel a distance d from one point to another when r≧0. Equation (18) provides the velocity that will be maintained in traveling the distance d from one point to another for constant specific power P₀ when r≧0.

TABLE 1
cₛ Values for Various Surface Types⁶³

| Surface Type w/r = 0 | cₛ |
|---|---|
| Asphalt | 1.0 |
| Grass | 1.09 |
| Broken field (rocks/potholes) | 1.25 |
| Forest | 1.28 |
| Marsh | 1.43 |

Negative gradient case. As already discussed under prior art, the literature on human energy expenditure indicates that traversing negative (downhill) gradients at constant specific power consumes less energy than does traversing flat terrain for −0.2≦r<0, but that when r<−0.2, energy consumption is greater than for flat terrain. This implies a model that incorporates r² terms. Therefore, for the case where r<0, we initially developed a full-factorial⁶⁴ multiple regression model with both r and v as factors:
P*=γ₀+γ₁cₛr+γ₂cₛv+γ₃cₛrv+γ₄cₛr²+γ₅cₛv²+γ₆cₛrv²+γ₇cₛr²v+γ₈cₛr²v² (24)

Empirical data for downhill walking from the literature^{65, 66, 67, 68} were used to estimate the parameters γ₀, γ₁, γ₂, γ₃, γ₄, γ₅, γ₆, γ₇, and γ₈. However, for this initial model, the t-statistic associated with γ₃ was <1, indicating that for negative gradients, the inclusion of the rv factor in the model makes the model, in terms of adjusted R², worse, not better⁶⁹. Deleting the rv factor resulted in a new conceptual model for r<0:
P*=γ₀+γ₁cₛr+γ₂cₛv+γ₄cₛr²+γ₅cₛv²+γ₆cₛrv²+γ₇cₛr²v+γ₈cₛr²v² (25)

Using empirical data to estimate the parameters of equation (25) yielded:
P*=0.03857+0.02352cₛr−0.006524cₛv+0.2681cₛr²+0.002064cₛv²+0.001551cₛrv²−0.03889cₛr²v+0.01482cₛr²v² (26)
Equation (26) has an adjusted R² value of 0.93. As in the positive gradient case, P* (m+l)=P must be less than or equal to 7.3 kcal/min.

Rearranging the terms of equation (26) gives a standard quadratic equation in v:
(0.002064+0.001551r+0.01482r²)cₛv²−(0.006524+0.03889r²)cₛv+(0.03857+0.02352cₛr−P*)=0 (27)
Now let:
(0.002064+0.001551r+0.01482r²)cₛ=a (28)
−(0.006524+0.03889r²)cₛ=b (29)
(0.03857+0.02352cₛr−P*)=c (30)

Substituting equations (28)-(30) into equation (27) yields:
av²+bv+c=0 (31)
Solving equation (31) for v produces:

$$v = \frac{- b \pm \sqrt{{b}^{2} - 4 ac}}{2 a} \qquad ( 32 )$$

However, since a>0, b<0, r<0, and c<0 for P*≧0.03587+0.02352cₛr, equation (32) may be replaced by:

$$v = \frac{- b + \sqrt{{b}^{2} - 4 ac}}{2 a} \qquad ( 33 )$$

Substituting the left hand sides of equations (28)-(30) for a, b, and c in equation (33) yields:

$$\begin{matrix}v = \{ ( .006524 + .03889 {r}^{2} ) {c}_{s} + [ {( .006524 + .03889 {r}^{2} )}^{2} {c}_{s}^{2} + \\ ( .008256 {P}^{*} - .0003184 ) {c}_{s} + \\ ( .006204 {P}^{*} - .002393 - .0001942 {c}_{s} ) {c}_{s} r + \\ ( .05928 {P}^{*} - .002286 - .0001459 {c}_{s} ) {c}_{s} {r}^{2} - \\ {{ .001394 {c}_{s}^{2} {r}^{3} ]}^{\frac{1}{2}} \} [ {c}_{s} ( .004128 + .003102 r + .02964 {r}^{2} ) ]}^{- 1}\end{matrix} \qquad ( 34 )$$

where v is the walking velocity for r<0, cₛ, and P*. If we let P*=Pₘₐₓ* (0.05748 kcal/kg-min for a 280 pound m+l), we obtain v=vₘₐₓ from equation (34), where vₘₐₓ is the theoretical maximum sustainable walking velocity for r<0, cₛ, and P*=Pₘₐₓ*.

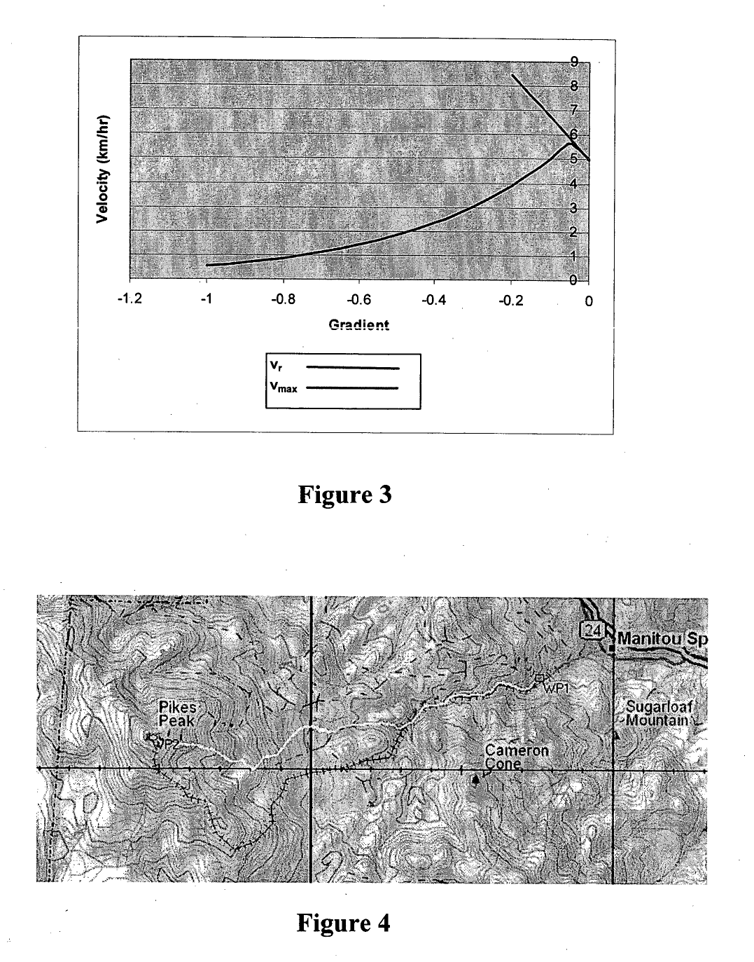

However, our field research indicates that when r<0, rather than maintaining a constant specific power P₀*=Pₘₐₓ*, a walking human maintains a velocity, vᵣ≦vₘₐₓ, that is a function of the gradient r and the terrain surface type multiplier cₛ. This velocity vᵣ is less than or equal to vₘₐₓ because a human naturally slows down as a negative gradient becomes steeper to avoid slipping and falling. We determined the following empirical equation for v, thorough our field research:

$${v}_{r} = \frac{{k}_{1} {v}^{*}}{{c}_{s}} {ⅇ}^{- \frac{\vert r - {r}^{*} \vert}{{k}_{2} {v}^{*}}} \qquad ( 35 )$$

where v*=vₘₐₓ(r=−0.05) is the vₘₐₓ associated with gradient r*=−0.05 and specific power P*=Pₘₐₓ*, k₁ is an empirically determined dimensionless scaling constant (0.961) and k₂ is another empirically determined scaling constant (6.7679×10⁻² hr/km). Our field research indicates that vᵣ reaches its maximum value at gradient r*=−0.05, as can be seen in FIG. 3, which is a graph of the relationship between r and vᵣ and r and vₘₐₓ for r<0 and cₛ=1, and P*=Pₘₐₓ*=0.05748 kcal/kg-min (for an assumed 280 pound m+l). FIG. 3 also shows that vᵣ≦Vₘₐₓ for all r<0. The vₘₐₓ graph was terminated at r=−0.2 to prevent compression of the scale for vᵣ in FIG. 3. Equation (35) is the formula for calculating human walking velocity associated with gradient r<0 and terrain type multiplier cₛ.

Now since:

$${v}_{r} = \frac{d}{t} \qquad ( 36 )$$

equation (36) can be solved for t:

$$t = \frac{d}{{v}_{r}} \qquad ( 37 )$$

where d is the distance from one point to another, and t is the time it takes to cover that distance at velocity vᵣ.

For r<0, we are seeking an expression for specific energy expenditure at velocity vᵣ, so we start with the general mathematical expression for specific energy:
E*=P*t (38)

Accordingly, to generate an expression for the specific energy required to walk a distance d over terrain characterized by cₛ when r<0, we substitute vᵣ for v in equation (26) and substitute equations (26) and (37) into equation (38), yielding:

$$- {E}^{*} = \frac{d}{{v}_{r}} ( .03857 + .02352 {c}_{s} r - .006524 {c}_{s} {v}_{r} + .2681 {c}_{s} {r}^{2} + .002064 {c}_{s} {v}_{r}^{2} \qquad ( 39 )$$

+0.001551cₛrvᵣ²−0.03889cₛr²vᵣ+0.01482cₛr²vᵣ²)

Equation (39), is the “cost” that must be minimized in calculating an optimal route when r<0. Equation (37) provides the time estimate to travel distance d when r<0. Equation (35) provides the velocity that will be maintained in traveling distance d over terrain with terrain type multiplier cₛ for gradient r<0.

Discussion. It is obvious that equations (23) and (39) are quite different so that the energy expenditure “costs” associated with each arc in the terrain network are different depending on which direction (and therefore gradient) one is traversing the arc. Therefore two energies are calculated and associated with each arc in the network.

Optimize the Path Through the Network. Using Dijktra's algorithm or one of its alternatives, compute the path through the terrain network that minimizes human energy expenditure from a user-designated starting point to one or more sequential user-designated points.

Display and/or Download the Optimal Path. The present invention can then either visually display the optimal path on a map graphic or convert it to a set of GPS coordinates for loading in a GPS navigation device or both.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A computer readable medium containing components that act cooperatively to provide instructions that cause a computer system to compute overland ground routes for one or more humans traveling on foot over arbitrary terrain between any set of two or more sequential points, and identify an optimal route that minimizes the human energy expended traveling between said sequential points.

2. The computer readable medium of claim 1 wherein said components include:
(a) a terrain component operable for receiving as input USGS or NIMA or other standard terrain elevation and terrain type data in grid cell format and converting said terrain elevation data to terrain network format;
(b) an energy expenditure computation component operable for computing and assigning appropriate energy expenditure values to each arc in the terrain network.
(c) A path optimization component comprising a network path optimization algorithm (e.g., Dijkstra's algorithm) operable for computing and identifying an optimal overland ground route for humans traveling on foot over arbitrary terrain, between said sequential points, said identifier optimal route selected such that said optimal route minimizes human energy expended traveling between said sequential points.
(d) An optimal path display/download component operable for either visually displaying the optimal path on a map graphic or converting said optimal route to a set of GPS coordinates and, upon receipt of a command by a user, downloads them to a GPS navigation device.

3. The computer readable medium of claim 2 wherein said optimal path display/download component is operable for visually displaying said optimal path on a map graphic and converting said optimal route to a set of GPS coordinates and, upon receipt of a command by a user, downloads said GPS coordinates to a GPS navigation device.
